(19) United States
(12) Patent Application Publication
(10) Pub. No.: US 2013/0050785 A1
(43) Pub. Date: Feb. 28, 2013

(54) ELECTRONIC CAMERA

(71) Applicant: Masayoshi Okamoto, Daito-shi (JP)

(72) Inventor: Masayoshi Okamoto, Daito-shi (JP)

(73) Assignee: SANYO ELECTRIC CO., LTD., Osaka (JP)

(21) Appl. No.: 13/572,999

(22) Filed: Aug. 13, 2012

(30) Foreign Application Priority Data
Aug. 26, 2011 (JP) 2011-185031

(51) Int. Cl. H04N 1/04; H04N 1/393; H04N 1/56

(52) U.S. Cl. 358/538; 358/479; 358/451

(57) ABSTRACT

An electronic camera includes an imager. An imager repeatedly outputs an image representing a scene captured on an imaging surface. A definer executes a process of defining a document page region within the scene captured on the imaging surface, corresponding to a document page photographing mode. A searcher searches for one or at least two characteristic images including a page edge from a partial image belonging to the document page region defined by the definer out of the image outputted from the imager. A detector detects a termination of a page turning operation based on a search result of the searcher. An extractor extracts the image outputted from the imager corresponding to a detection of the detector.

### CROSS REFERENCE OF RELATED APPLICATION

The disclosure of Japanese Patent Application No. 2011-185031, which was filed on Aug. 26, 2011, is incorporated herein by reference.

### BACKGROUND OF THE INVENTION

1. Field of the Invention

The present invention relates to an electronic camera and in particular, relates to an electronic camera which has a function of shooting a document page.

2. Description of the Related Art

According to one example of this type of camera, a manuscript of a readout target is supported by a copy holder. A manuscript image is converted into an electric signal by an imager. An open space for setting the manuscript exists between the copy holder and the imager. A ranging sensor is placed on an upper side of the copy holder so as to measure an objective distance in a direction toward the copy holder. The manuscript image is read in response to a change of the objective distance measured by the ranging sensor. Thereby, it becomes possible to reduce a work burden for reading a plurality of manuscript images.

However, in the above-described camera, executing/suspending a page turning operation is determined based on output of the ranging sensor arranged separately from the imager, and therefore, there is a problem in that a composition becomes complicated.

### SUMMARY OF THE INVENTION

An electronic camera according to the present invention, comprises; an imager which repeatedly outputs an image representing a scene captured on an imaging surface; a definer which executes a process of defining a document page region within the scene captured on the imaging surface, corresponding to a document page photographing mode; a searcher which searches for one or at least two characteristic images including a page edge from a partial image belonging to the document page region defined by the definer out of the image outputted from the imager; a detector which detects a termination of a page turning operation based on a search result of the searcher; and an extractor which extracts the image outputted from the imager corresponding to a detection of the detector.

According to the present invention, An imaging control program recorded on a non-transitory recording medium in order to control an electronic camera provided with an imager which outputs an image representing a scene captured on an imaging surface, the program causing a processor of the electronic camera to perform the steps comprises: a defining step of executing a process of defining a document page region within the scene captured on the imaging surface, corresponding to a document page photographing mode; a searching step of searching for one or at least two characteristic images including a page edge from a partial image belonging to the document page region defined by the defining step out of the image outputted from the imager; a detecting step of detects a termination of a page turning operation based on a search result of the searching step; and an extracting step of extracting the image outputted from the imager corresponding to a detection of the detecting step.

According to the present invention, An imaging control method executed by an electronic camera provided with an imager which outputs an image representing a scene captured on an imaging surface, comprises: a defining step of executing a process of defining a document page region within the scene captured on the imaging surface, corresponding to a document page photographing mode; a searching step of searching for one or at least two characteristic images including a page edge from a partial image belonging to the document page region defined by the defining step out of the image outputted from the imager; a detecting step of detects a termination of a page turning operation based on a search result of the searching step; and an extracting step of extracting the image outputted from the imager corresponding to a detection of the detecting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a state where a digital camera shown in FIG. 2 is attached to a jig fixed on a desk;

FIG. 4 is an illustrative view showing another example of the state where the digital camera shown in FIG. 2 is attached to the jig fixed on the desk;

FIG. 5 is an illustrative view showing one portion of a photographing operation in a document page photographing mode;

FIG. 6 is an illustrative view showing another portion of the photographing operation in the document page photographing mode;

FIG. 7 is an illustrative view showing one example of a dictionary image referred to in the document page photographing mode;

FIG. 8 is an illustrative view showing still another portion of the photographing operation in the document page photographing mode;

FIG. 9 is a flowchart showing one portion of behavior of a CPU applied to the embodiment in FIG. 2;

FIG. 10 is a flowchart showing another portion of behavior of the CPU applied to the embodiment in FIG. 2;

FIG. 11 is a flowchart showing still another portion of behavior of the CPU applied to the embodiment in FIG. 2;

FIG. 12 is a flowchart showing yet another portion of behavior of the CPU applied to the embodiment in FIG. 2;

FIG. 13 is a flowchart showing another portion of behavior of the CPU applied to the embodiment in FIG. 2;

FIG. 14 is a flowchart showing still another portion of behavior of the CPU applied to the embodiment in FIG. 2;

FIG. 15 is a flowchart showing yet another portion of behavior of the CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is a flowchart showing yet another portion of behavior of the CPU applied to the embodiment in FIG. 2; and

FIG. 19 is a block diagram showing a basic configuration of another embodiment of the present invention.

### DETAILED DESCRIPTION OF THE PREFERRED EMBODIMENTS

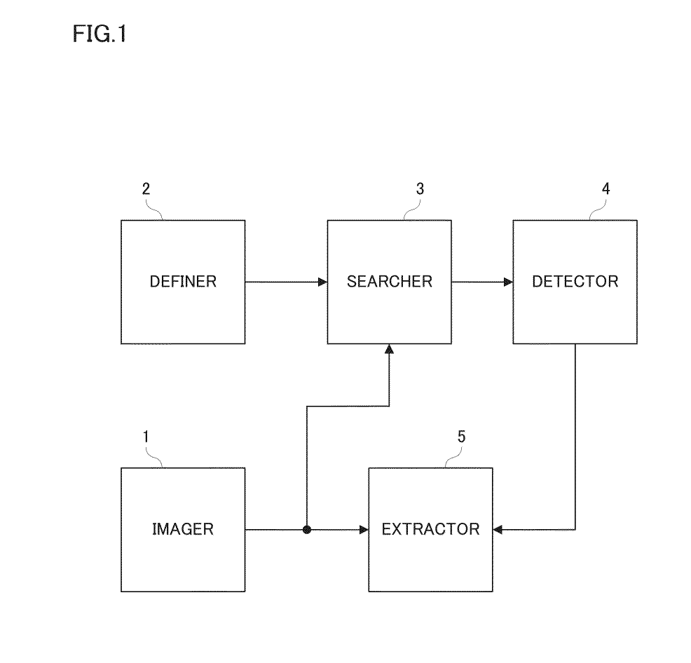

With reference to FIG. 1, an electronic camera according to one embodiment of the present invention is basically configured as follows: An imager 1 repeatedly outputs an image representing a scene captured on an imaging surface. A definer 2 executes a process of defining a document page region within the scene captured on the imaging surface, corresponding to a document page photographing mode. A searcher 3 searches for one or at least two characteristic images including a page edge from a partial image belonging to the document page region defined by the definer 2 out of the image outputted from the imager 1. A detector 4 detects a termination of a page turning operation based on a search result of the searcher 3. An extractor 5 extracts the image outputted from the imager 1 corresponding to a detection of the detector 4.

When the document photographing mode is selected, the document page region is defined within the scene captured on the imaging surface, and one or at least two characteristic images including the page edge is searched from the partial image belonging to the document page region. When the termination of the page turning operation is detected based on the search result, corresponding thereto, the image outputted from the imager 1 is extracted. Thereby, a complication of a composition is inhibited, and an imaging performance for the document page is improved.

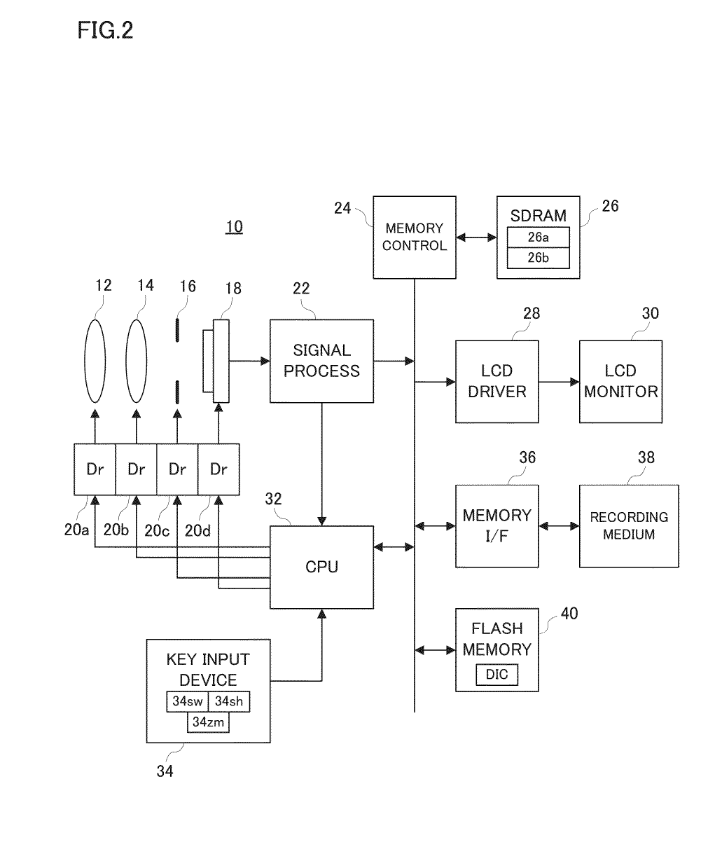

With reference to FIG. 2, a digital camera 10 according to one embodiment includes a zoom lens 12, a focus lens 14 and an aperture unit 16 driven by drivers 20a to 20c, respectively. An optical image of a scene that underwent these components enters, with irradiation, an imaging surface of an imager 18, and is subjected to a photoelectric conversion.

A CPU 32 is a CPU which executes a plurality of tasks on a multi task operating system such as the μITRON, in a parallel manner. When a power source is applied, under a main task, the CPU 32 executes a process of determining an operation mode being selected at a current time point, and a process of activating a task corresponding to the determined operation mode. When a determined operation mode is a normal photographing mode, a normal photographing task is activated whereas when the determined operation mode indicates the document page photographing mode, a page photographing task is activated. When a mode selector button 34sw arranged in a key input device 34 is operated, the task that is being activated is stopped, and a task corresponding to the operation mode selected by the operation of the mode selector button 34sw is activated alternately.

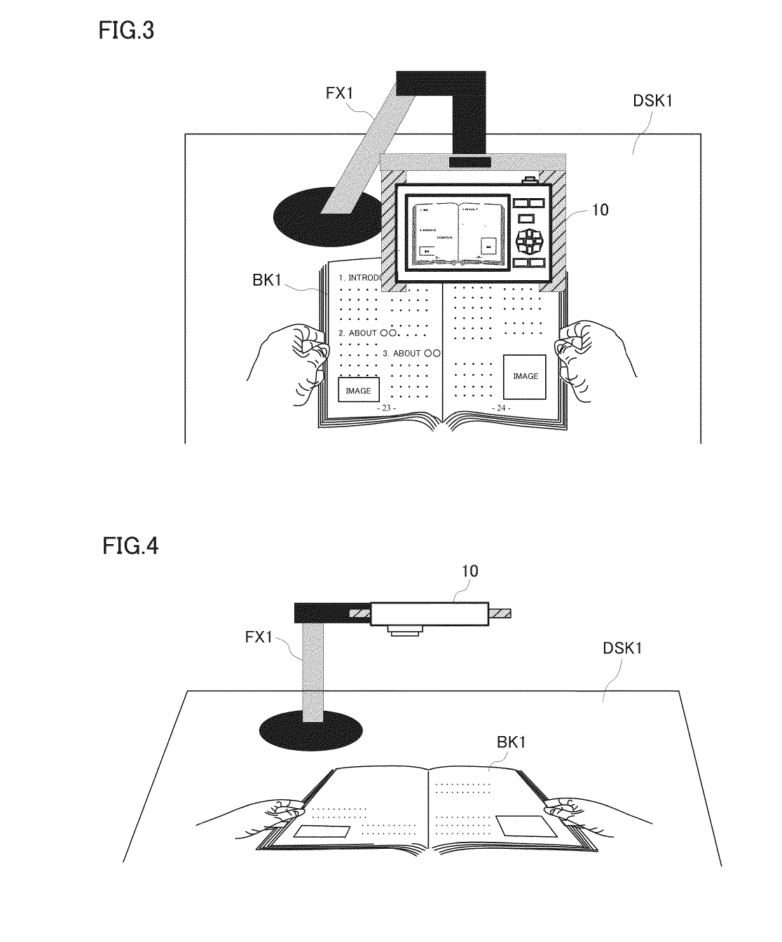

It is noted that the document photographing mode is assumed that a dedicated jig FX1 fixed on a desk DSK1 is prepared as shown in FIG. 3 to FIG. 4, the digital camera 10 is attached to the jig FX1 in a posture of the imaging surface being downward, and a document BK1 is placed on the desk DSK1 so that the document page is captured on the imaging surface.

When the normal photographing task is activated, in order to execute a moving-image taking process, the CPU 32 commands a driver 20d to repeat an exposure procedure and a electric-charge reading-out procedure. In response to a vertical synchronization signal Vsync periodically generated, the driver 20d exposes the imaging surface of the imager 18 and reads out the electric charges produced on the imaging surface in a raster scanning manner. From the imager 18, raw image data that is based on the read-out electric charges is cyclically outputted.

A signal processing circuit 22 performs processes such as a white balance adjustment, a color separation, and a YUV conversion on the raw image data outputted from the imager 18. YUV-formatted image data generated thereby is written into a YUV image area 26a of an SDRAM 26 through a memory control circuit 24. An LCD driver 28 repeatedly reads out the image data stored in the YUV image area 26a through the memory control circuit 24, and drives an LCD monitor 30 based on the read-out image data. As a result, a real-time moving image (live view image) representing a scene captured on the imaging surface is displayed on a monitor screen.

Moreover, the signal processing circuit 22 applies Y data forming the image data to the CPU 32. The CPU 32 performs a simple AE process on the applied Y data so as to calculate an appropriate EV value and set an aperture amount and an exposure time period that define the calculated appropriate EV value to the drivers 20c and 20d, respectively. Thereby, the raw image data outputted from the imager 18, by extension, a brightness of a live view image displayed on the LCD monitor 30 is adjusted approximately.

When a zoom button 34zm arranged in the key input device 34 is operated, the CPU 32 controls the driver 20a so as to move the zoom lens 12 in an optical-axis direction. As a result, a magnification of an optical image irradiated on the imaging surface, by extension, a magnification of a live view image displayed on the LCD monitor 30 is changed.

When a shutter button 34sh arranged in the key input device 34 is half-depressed, the CPU 32 performs a strict AE process on the Y data applied from the signal processing circuit 22 so as to calculate an optimal EV value. Aperture amount and an exposure time period that define the calculated optimal EV value are set to the drivers 20c and 20d, respectively. As a result, a brightness of a live view image is adjusted strictly. Moreover, the CPU 32 performs an AF process on a high-frequency component of the Y data applied from the signal processing circuit 22. Thereby, the focus lens 14 is placed at a focal point, and as a result, the raw image data outputted from the imager 18, by extension, a sharpness of a live view image displayed on the LCD monitor 30 is improved. When the shutter button 34sh is fully depressed, the CPU 32 executes a still-image taking process, and concurrently, commands a memory I/F 36 to execute a recording process.

Image data representing a scene at a time point at which the shutter button 34sh is fully depressed is evacuated from the YUV image area 26a to a still-image area 26b by the still-image taking process. The memory I/F 36 commanded to execute the recording process reads out the image data evacuated to the still-image area 26b through the memory control circuit 24 so as to record an image file containing the read-out image data on a recording medium 38.

When the document photographing task is activated in a state where the digital camera 10 is attached to the jig FX1 shown in FIG. 3 to FIG. 4 and the document BK1 on the desk DSK1 is opened by a left hand HD_L and a right hand HD_R, the CPU 32 executes the above-described moving-image taking process. As a result, a live view image representing the document BK1 is displayed on the LCD monitor 30.

When the shutter button 34sh is operated in this state, the CPU 32 regards that a document-page photographing-start operation is performed, and searches for a document page from the image data stored in the YUV image area 26a. When the document page is detected, the CPU 32 defines a region covering the detected document page as a document page region PR1 (see FIG. 5), and adjusts a zoom magnification (=a position of the zoom lens 12) so that the defined document page region PR1 accounts for 90 percent of the image data. As a result of the zoom magnification being adjusted, in FIG. 5, an image of a region surrounded by a heavy line is displayed on the LCD monitor 30.

Upon completion of adjusting the zoom magnification, a center-page spread state detecting task is activated. Under the center-page spread state detecting task, page-turning determination processes 1 to 3 are executed at every time the vertical synchronization signal Vsync is generated. The page-turning determination process 1 is executed with reference to a page edge, the page-turning determination process 2 is executed with reference to a finger of a person, and the page-turning determination process 3 is executed with reference to a color of a hand.

However, when a determined result indicating a “page-turning-operation stopped state” is acquired in the page-turning determination process 1, the page-turning determination process 2 is complementary executed in order to verify a reliability of the determined result. Furthermore, when a determined result indicating “a page-turning-operation stopped state” is acquired in the page-turning determination process 2, the page-turning determination process 3 is complementary executed in order to verify a reliability of the determined result.

In the page-turning determination process 1, firstly, a line segment equivalent to the longest portion of a vertical edge forming the document page is searched from the image data belonging to the document page region PR1. Specifically, a searching target is the longest line segment among one or at least two line segments each of which has an inclination θ1 equal to or less than 45 degrees and a length equal to or more than 40 percent of a vertical size of the document page region PR1. A length of the detected line segments is set to a variable EhL1.

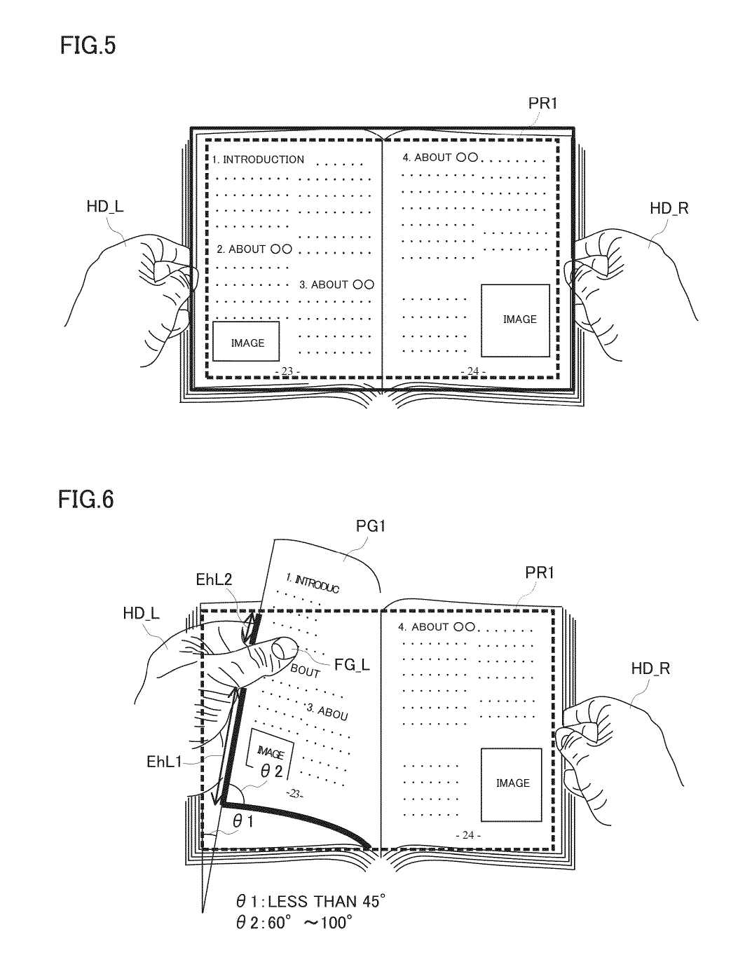

In an example shown in FIG. 6, a vertical edge of a document page PG1 turned by the left hand HD_L appears in the document page region PR1. Out of this vertical edge, a line segment equivalent to a vertical edge below a thumb FG_L is detected as the longest line segment, and a length of the detected line segment is set as the variable EhL1.

Subsequently, a line segment being on an extended line of the detected line segment is detected from the image data belonging to the document page region PR1. The detected line segment is another portion of the line segment forming the same vertical edge, and a length of the detected ling segment is set to a variable EhL2. In the example shown in FIG. 6, a line segment equivalent to a vertical edge above the thumb FG_L is detected, and a length of the detected line segment is set as the variable EhL2.

When a total sum of the variables EhL1 and EhL2 is equal to or more than 50 percent and less than 70 percent of the vertical size of the document page region PR1, a line segment equivalent to a horizontal edge of the document page is additionally searched. Specifically, a searching target is equivalent to a line segment having θ2 which is an angle intersect with the vertical edge detected in a manner described above belonging to a range from 60 degrees to 100 degrees and a length equal to or more than 70 percent of a horizontal size of the document page. In the example shown in FIG. 6, a line segment equivalent to a horizontal edge of the document page PG1 is detected.

The determined result of the page-turning determination process 1 indicates a “page-turning-operation executed state” when the total sum of the variables EhL1 and EhL2 is equal to or more than 70 percent of the vertical size of the document page region.

Moreover, the determined result of the page-turning determination process 1 is regarded as the “page-turning-operation executed state” when the total sum of the variables EhL1 and EhL2 is equal to or more than 50 percent and less than 70 percent of the vertical size of the document page region and the line segment equivalent to the horizontal edge of the document page is detected.

In contrary, when the vertical edge of the document page is not detected, when a length of the detected vertical edge (=EhL1+EhL2) is less than 50 percent, or when the length of the detected vertical edge is in a range from 50 percent to 70 percent and the horizontal edge is not detected, the determined result of the page-turning determination process 1 indicates the “page-turning-operation stopped state”.

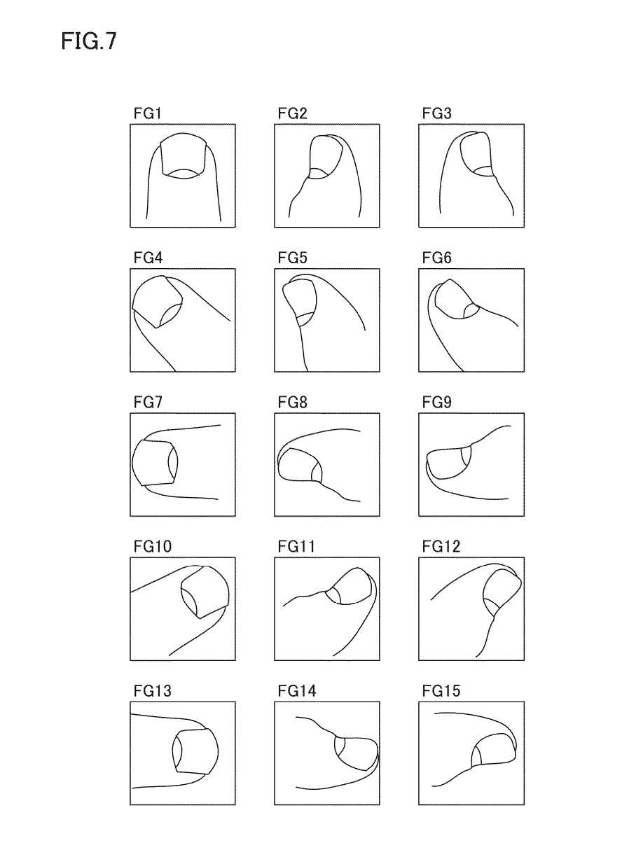

In the page-turning determination process 2, an image representing the finger (=finger image) is searched from the document page region PR1. Upon searching, dictionary images FG1 to FG15 shown in FIG. 7 contained in a dictionary DIC of a flash memory 40 are referred to. When a partial image coincident with any one of the dictionary images FG1 to FG1 is detected, it is regarded that the finger image exists in the document page region PR1. Furthermore, when a color of the detected finger image does not approximate a color of a margin of the document page, a numerical value indicating the color of the detected finger image is set to a variable HandColor.

In the example of FIG. 6, a partial image representing the thumb FG_L coincides with the dictionary image FG10 or FG11 shown in FIG. 7. At this time, a numerical value indicating a color of the thumb FG_L is set to the variable HandColor on the condition that the color of the thumb FG_L does not approximate the color of the margin of the document page RG1.

The determined result of the page-turning determination process 2 indicates the “page-turning-operation executed state” when the finger image is detected from the document page region PR1, and indicates the “page-turning-operation stopped state” when the finger image is not detected from the document page region PR1.

In the page-turning determination process 3, a group image having the same color as the color specified by the variable HandColor is extracted from the image data belonging to the document page region PR1, and a dimension of the extracted group image is compared with a threshold value THdm. In the example of FIG. 6, on the condition that the color of the thumb FG_L does not approximate the color of the margin of the document page RG1, an image representing the left hand HD_L appeared in the document page region PR1 is extracted, and a dimension of the extracted image is compared with the threshold value THdm.

When the dimension exceeds the threshold value THdm, the determined result of the page-turning determination process 3 indicates the “page-turning-operation executed state”. In contrary, when the dimension of the group is equal to or less than the threshold value THdm, or when the variable HandColor is not set, the determined result of the page-turning determination process 3 indicates the “page-turning-operation stopped state”.

In the document page photographing task, the termination of the page turning operation is detected by noticing a temporal change of the determined results. While the termination of the page turning operation is not detected, the CPU 32 repeatedly executes the simple AE process. As a result, a brightness of a live view image is adjusted approximately.

In contrary, when the termination of the page turning operation is detected, the CPU 32 executes the strict AE process and the AF process, and concurrently, executes the still-image taking process. As a result, image data representing a scene at a time point at which the page turning operation is ended and in which a brightness and a sharpness are strictly adjusted is evacuated from the YUV image area 26a to a still-image area 26b.

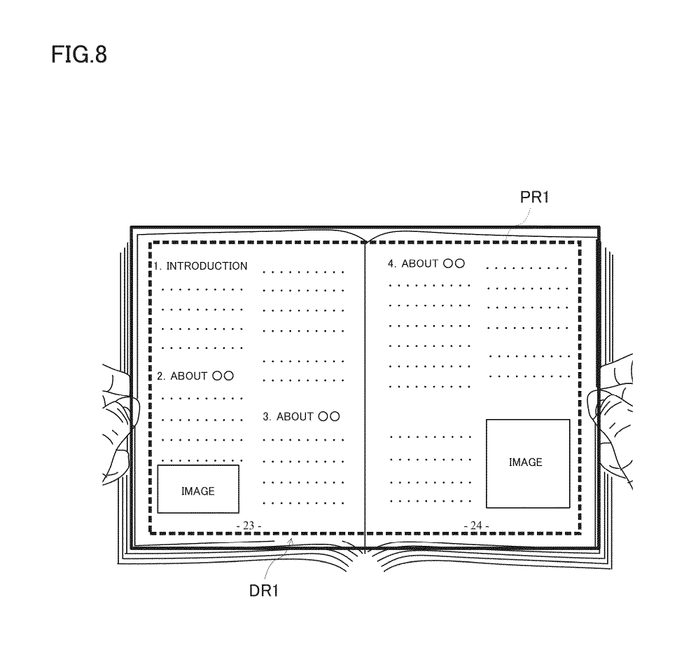

Upon completion of an evacuating process, an image modifying process is executed. In the image modifying process, a region surrounding the document page region PR1 is set as an unnecessary-image detection region DR1, and a color of the unnecessary-image detection region DR1 is changed to the color of the margin of the document page. As a result, in the example of FIG. 6, the unnecessary-image detection region DR1 is set as shown in FIG. 8, and an image of the set region is filled by the color of the margin of the document page.

The process is executed at every time the document page is turned, and as a result, one or at least two frames of image data are evacuated to a still-image area 26b. When the shutter button 34sh is operated again in order to end photographing the document page, the CPU 32 commands the memory I/F 36 to execute the recording process. The memory I/F 36 reads out the one or at least two image data evacuated to the still-image area 26b through the memory control circuit 24 so as to record a single image file containing the read-out image data on the recording medium 38.

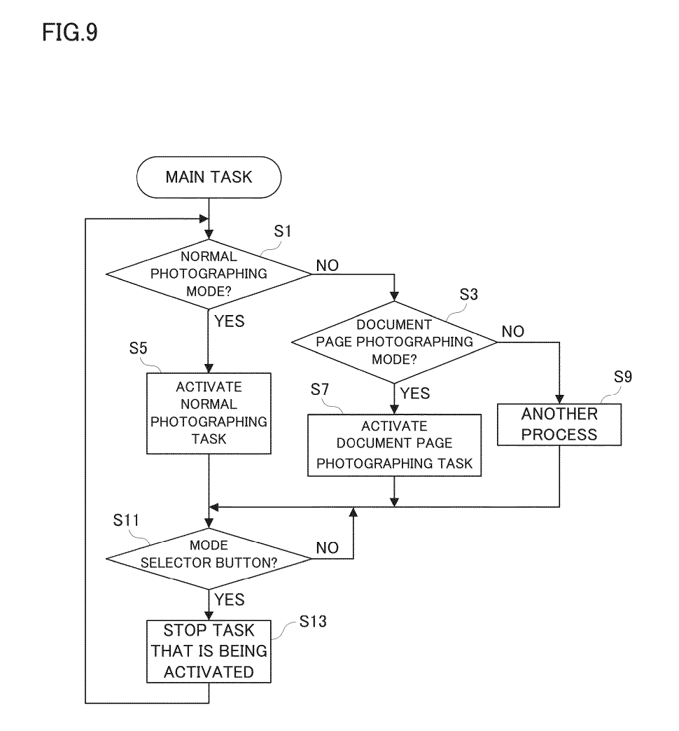

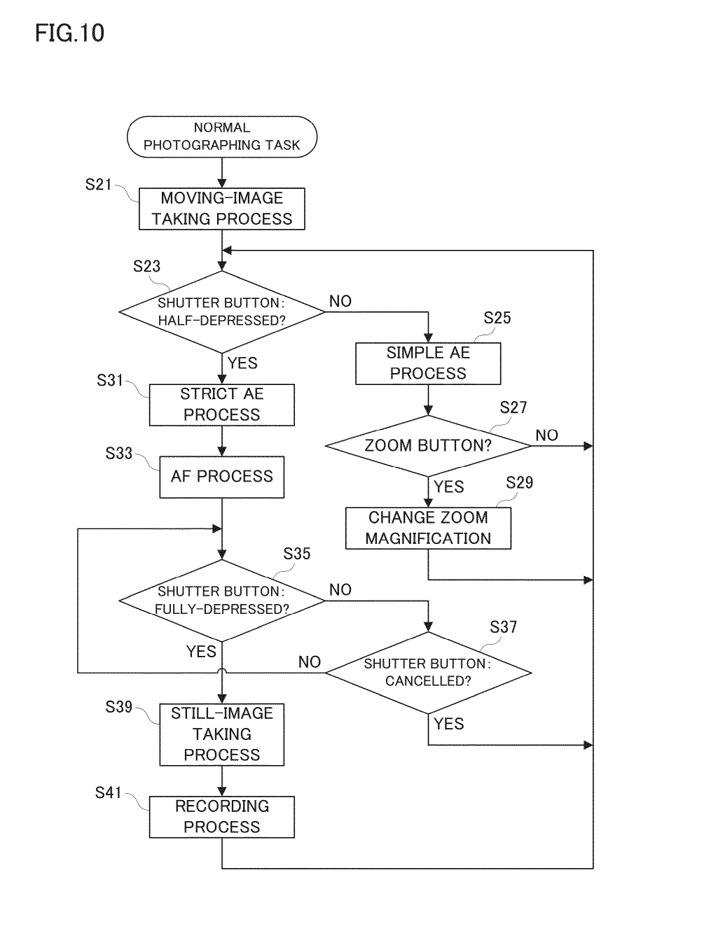

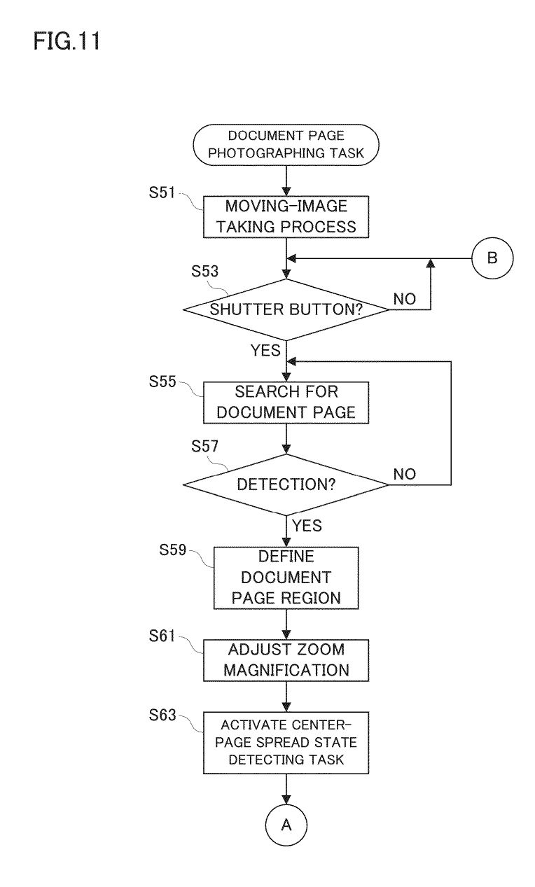

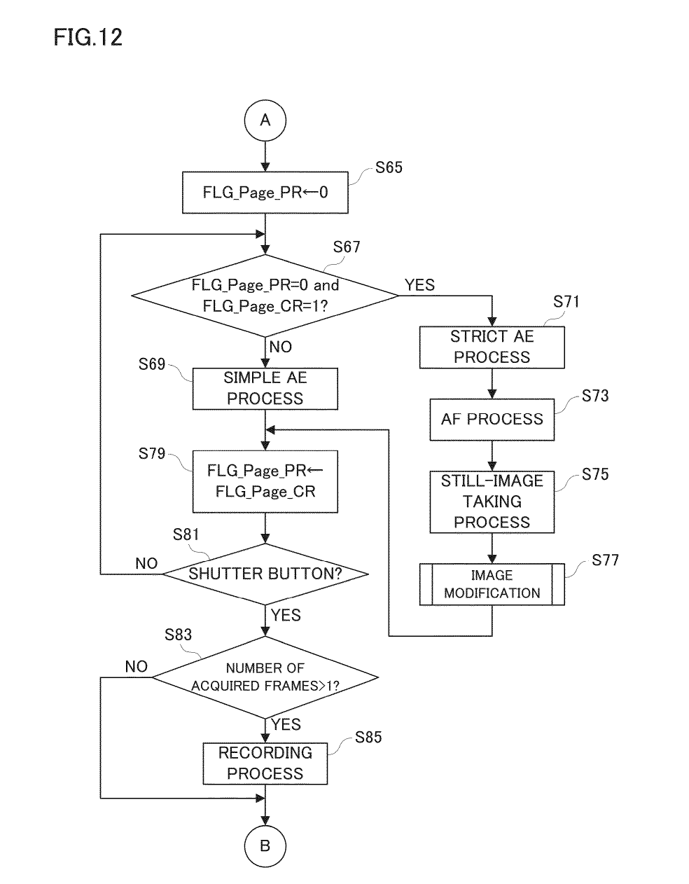

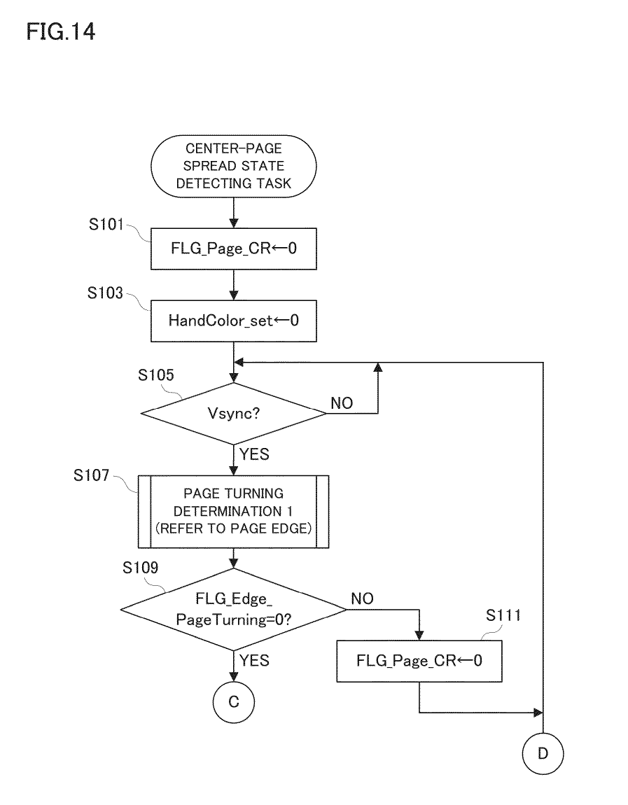

The CPU 32 executes following tasks: the main task shown in FIG. 9 irrespective of the operation mode; the normal photographing task shown in FIG. 10 when the normal photographing mode is selected; and the document page photographing task shown in FIG. 11 to FIG. 13 and the center-page spread state detecting task shown in FIG. 14 to FIG. 18 when the document page photographing mode is selected. It is noted that control programs corresponding to these tasks are stored in the flash memory 40.

With reference to FIG. 9, in a step S1, it is determined whether or not an operation mode at a current time point is the normal photographing mode, and in a step S3, it is determined whether or not an operation mode at a current time point is the document page photographing mode. When a determined result of the step S1 is YES, in a step S5, the normal photographing task is activated, and when a determined result of the step S3 is YES, in a step S7, the document page photographing task is activated. It is noted that, when the operation mode at a current time point is not any of the normal photographing mode and the document page photographing mode, in a step S9, another process is executed.

Upon completion of the process in the step S5, S7 or S9, in a step S11, it is repeatedly determined whether or not the mode selector button 34sw is operated. When a determined result is updated from NO to YES, the task that is being activated is stopped in a step S13, and thereafter, the process returns to the step S1.

With reference to FIG. 10, in a step S21, the moving-image taking process is executed. As a result, a live view image is displayed on the LCD monitor 30. In a step S23, it is determined whether or not the shutter button 34sh is half-depressed, and when a determined result is NO, the process advances to a step S25 whereas when the determined result is YES, the process advances to a step S31.

In the step S25, the simple AE process is executed. As a result, a brightness of a live view image is adjusted approximately. Upon completion of the simple AE process, in a step S27, it is determined whether or not the zoom button 34zm is operated. When a determined result is NO, the process directly returns to the step S23 whereas when the determined result is YES, in a step S29, a zoom magnification is changed (=the zoom lens 12 is moved in an optical-axis direction). Thereafter, the process returns to the step S23. As a result of the process in the step S29, a magnification of a live view image is changed.

When the shutter button 34sh is half-depressed, in the step S31, the strict AE process is executed, and in a step S33, the AF process is executed. As a result, a brightness and a sharpness of a live view image are adjusted strictly. In a step S35, it is determined whether or not the shutter button 34sh is fully depressed, and in a step S37, the operation of the shutter button 34sh is cancelled. When a determined result of the step S37 is YES, the process directly returns to the step S23. When a determined result of the step S35 is YES, in a step S39, the still-image taking process is executed, and in a step S41, the memory I/F 36 is commanded to execute the recording process. Thereafter, the process returns to the step S23.

As a result of the process in the step S39, image data representing a scene at a time point at which the shutter button 34sh is fully depressed is evacuated from the YUV image area 26a to the still-image area 26b. Moreover, as a result of the process in the step S41, the memory I/F 36 reads out the image data evacuated to the still-image area 26b through the memory control circuit 24 so as to record an image file containing the read-out image data on the recording medium 38.

With reference to FIG. 11, in a step S51, the moving-image taking process same as in the step S21. As a result, a live view image is displayed on the LCD monitor 30. In a step S53, it is repeatedly determined whether or not the shutter button 34sh is operated. When a determined result is updated from NO to YES, it is regarded that the document-page photographing-start operation is performed, and thereafter, the process advances to a step S55.

In a step S55, a document page is searched from the image data stored in the YUV image area 26a, and in a step S57, it is determined whether or not the document page is detected. When a determined result is NO, the process returns to the step S57 whereas when the determined result is YES, the process advances to a step S59. In a step S59, a region covering the detected document page is defined as a document page region PR1.

In a step S61, a zoom magnification (=a position of the zoom lens 12) is adjusted so that the defined document page region PR1 accounts for 90 percent of the image data, and in a step S63, the center-page spread state detecting task is activated. In a step S65, a flag FLG_Page_PR is set to “0”, and in a step S67, it is determined whether or not a logical AND condition under which the flag FLG_Page_PR indicates “0” and a flag FLG_Page_CR indicates “1” is satisfied.

Here, the flag FLG_Page_PR is a flag for identifying whether the page turning operation is in the executed state or the stopped state at a timing equivalent to a prior frame. Moreover, the flag FLG_Page_CR is a flag for identifying whether the page turning operation is in the executed state or the stopped state at a timing equivalent to a current frame. In both of the flags, “0” indicates the executed state whereas “1” indicates the stopped state. Moreover, a value of the flag FLG_Page_CR is controlled by the center-page spread state detecting task.

When a determined result is NO, it is regarded that a state at a current time point is a state on a page turning (FLG_Page_PR=FLG_Page_CR=0) or a state after the page turning (FLG_Page_PR=FLG_Page_CR=1), and in a step S69, the simple AE process is executed. Thereafter, the process advances to a step S79.

In contrary, when the determined result of the step S67 is YES, it is regarded that a state at a current time point is a state immediately after the page turning, and in a step S71 or S73, the strict AE process and the AF process are executed. Concurrently, in a step S75, the still-image taking process is executed. As a result, image data representing a scene at a time point at which the page turning operation is ended and in which a brightness and a sharpness are strictly adjusted is evacuated from the YUV image area 26a to the still-image area 26b. Upon completion of the process in the step S75, in a step S77, the image modifying process is executed, and thereafter, the process advances to the step S79. As a result of the process in the step S77, an image of the unnecessary-image detection region DR1 surrounding the document page region PR1 is filled by the color of the margin of the document page.

In a step S79, the value of the flag FLG_Page_CR is set to the FLG_Page_PR. In a step S81, it is determined whether or not the shutter button 34sh is operated again, and when a determined result is NO, the process returns to the step S67 whereas when the determined result is YES,

In a step S83, it is determined whether or not one or at least two frames of image data are evacuated to a still-image area 26b, and when a determined result is NO, the process returns to the step S53 whereas when the determined result is YES, in a step S85, the memory I/F 36 is commanded to execute the recording process. The memory I/F 36 reads out the one or at least two image data evacuated to the still-image area 26b through the memory control circuit 24 so as to record a single image file containing the read-out image data on the recording medium 38. Upon completion of the recording process, the process returns to the step S53.

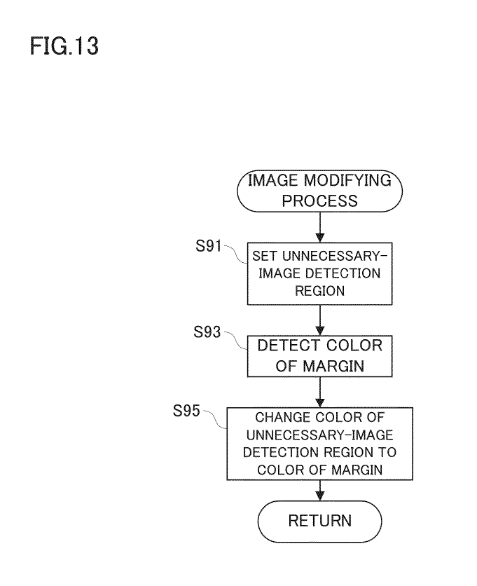

The image modifying process in the step S77 is executed according to a subroutine shown in FIG. 13. In a step S91, a region surrounding the document page region PR1 is set as the unnecessary-image detection region DR1, and in a step S93, the color of the margin of the document page is detected with reference to image data belonging to the document page region PR1. In a step S95, a color of an image belonging to the unnecessary-image detection region DR1 is changed to the color detected in the step S93. Upon completion of the process in the step S95, the process returns to the routine in an upper hierarchy.

With reference to FIG. 14, in a step S104, the flag FLG_Page_CR is set to “0”, and in a step S103, a variable Handcolor_set is set to “0”. In a step S105, it is repeatedly determined whether or not the vertical synchronization signal Vsync is generated. When a determined result is updated from NO to YES, in a step s107, the page-turning determination process 1 is executed with reference to a page edge. A flag FLG_Edge_Page Turning is set to “1” when the page edge is detected from the image data belonging to the document page region PR1 whereas is set to “0” when the page edge is not detected from the image data belonging to the document page region PR1.

In a step S109, it is determined whether or not the flag FLG_Edge_Page Turning indicates “0”. When a determined result is NO, in a step S111, the flag FLG_Page_CR is set to “0”, and thereafter, the process returns to the step S105. In contrary, when the determined result is YES, in a step S113, the page-turning determination process 2 is executed with reference to the finger of the person. A flag FLG_Finger_Page Turning is set to “1” when the finger image is detected from the image data belonging to the document page region PR1 whereas is set to “0” when the finger image is not detected from the image data belonging to the document page region PR1.

In a step S115, it is determined whether or not the flag FLG_Finger_Page Turning indicates “0”. When a determined result is NO, in a step S123, the flag FLG_Page_CR is set to “0”, and thereafter, the process returns to the step S105. In contrary, when the determined result is YES, in a step S117, the page-turning determination process 3 is executed with reference to the color of the hand. A flag FLG_HandColor_Page Turning is set to “1” when a dimension of the group image having the same color as the color of the finger image and existing in the document page RG1 exceeds the threshold value THdm whereas is set to “0” when the condition is not satisfied.

In a step S119, it is determined whether or not the flag FLG_HandColor_Page Turning indicates “0”. When a determined result is NO, in the step S123, the flag FLG_Page_CR is set to “0”, and thereafter, the process returns to the step S105. In contrary, when a determined result is YES, in a step S121, the flag FLG_Page_CR is set to “1”, and thereafter, the process returns to the step S105.

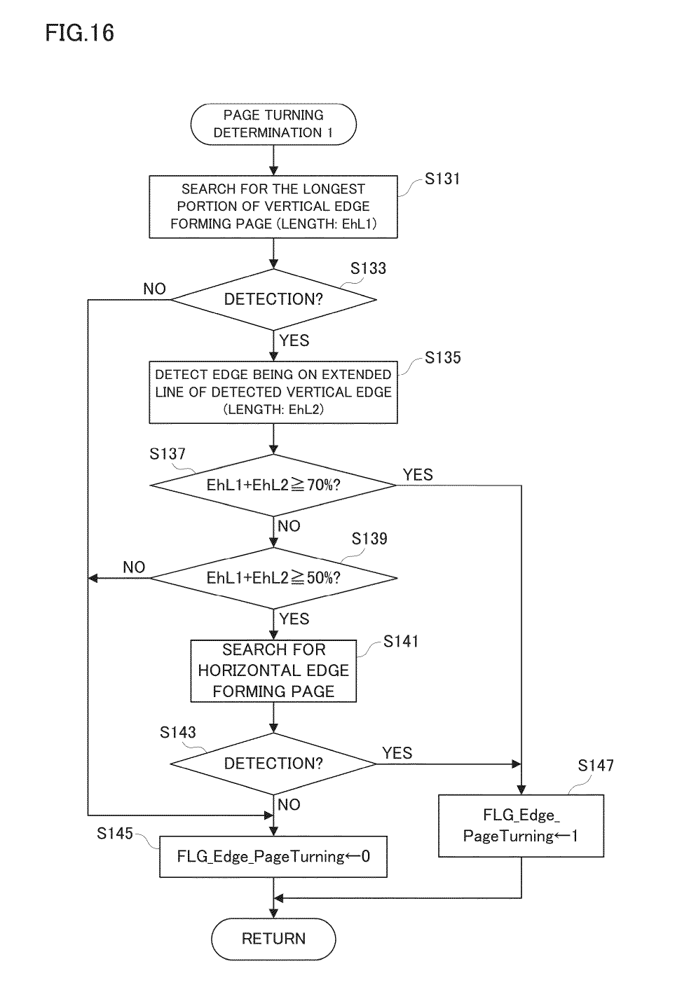

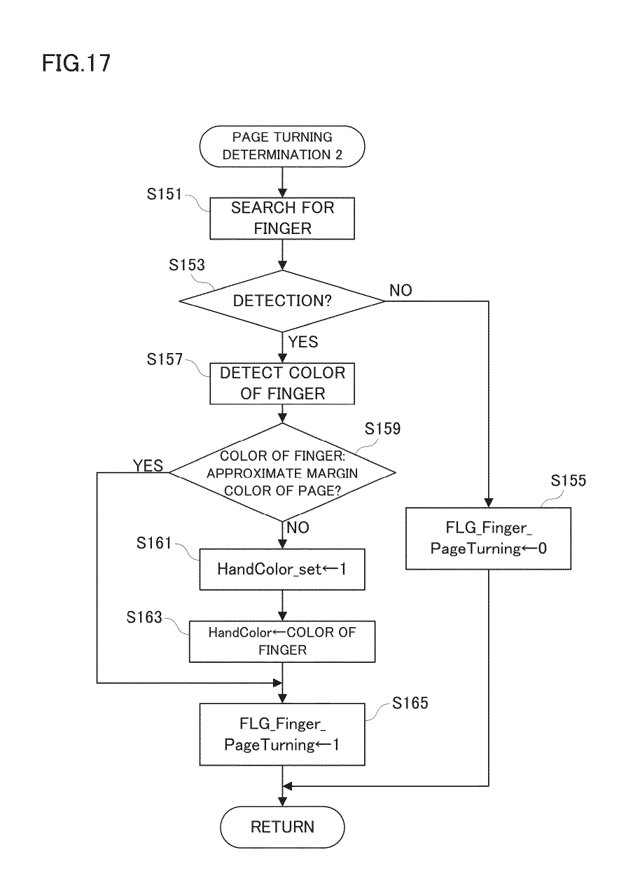

The page-turning determination process 1 in the step S107 shown in FIG. 14 is executed according to a subroutine shown in FIG. 16. In a step S131, the longest portion of the vertical edge forming the document page is searched from the image data belonging to the document page region PR1. Specifically, a searching target is the longest line segment among one or at least two line segments each of which has the inclination θ1 equal to or less than 45 degrees and a length equal to or more than 40 percent of a vertical size of the document page region PR1. A length of the detected line segments is set to the variable EhL1.

In a step S133, it is determined whether or not the searching target is detected. When a determined result is NO, in a step S145, the flag FLG_Edge_Page Turning is set to “0”, and thereafter, the process returns to the routine in an upper hierarchy. On the other hand, when the determined result is YES, the process advances to a step S135, and a line segment being on an extended line of the line segment detected in the step S131 is detected from the image data belonging to the document page region PR1. A length of the detected ling segment is set to the variable EhL2.

In a step S137, it is determined whether or not the total sum of the variables EhL1 and EhL2 is equal to or more than 70 percent of the vertical size of the document page region PR1. Moreover, in step S139, the total sum of the variables EhL1 and EhL2 is equal to or more than 50 percent of the vertical size of the document page region PR1.

When a determined result of the step S137 is YES, in a step S147, the flag FLG_Edge_Page Turning is set to “1”, and thereafter, the process returns to the routine in an upper hierarchy. When both of the determined result of the step S137 and a determined result of the step S139 are NO, the process returns to the routine in an upper hierarchy via the process in the step S145.

When the determined result of the step S137 is NO whereas the determined result of the step S139 is YES, in a step S141, the horizontal edge forming the document page is detected. Specifically, a searching target is equivalent to a line segment having θ2 which is an angle intersect with the vertical edge detected in a manner described above belonging to a range from 60 degrees to 100 degrees and a length equal to or more than 70 percent of a horizontal size of the document page. In a step S143, it is determined whether or not the line segment is detected, and when a determined result is NO, the process returns to the routine in an upper hierarchy via the process in the step S145 whereas when the determined result is YES, the process returns to the routine in an upper hierarchy via the process in the step S147.

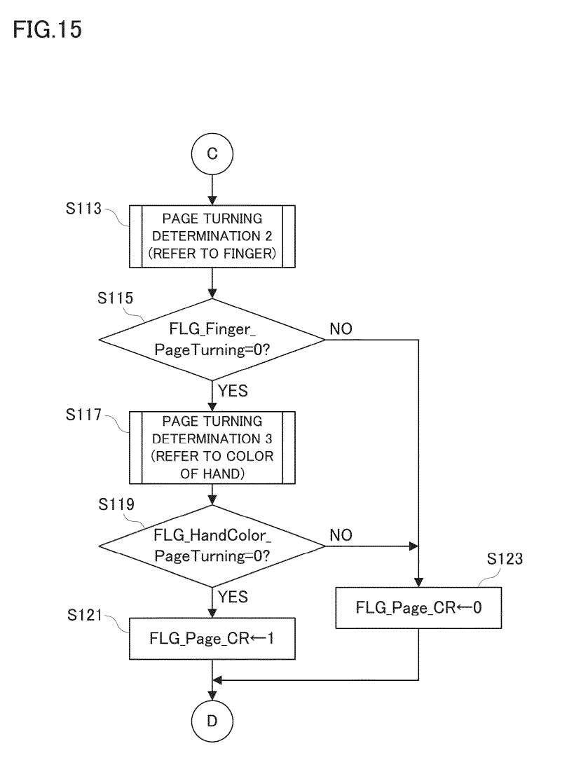

The page-turning determination process 2 of the step S113 shown in FIG. 15 is executed according to a subroutine shown in FIG. 17. In a step S151, the finger image is searched from the document page region. Upon searching, the dictionary images FG1 to FG15 contained in the dictionary DIC are referred to. In a step S153, it is determined whether or not the finger image is detected. When a determined result is NO, in a step S155, the FLG_Finger_PageTurning is set to “0”, and thereafter, the process returns to the routine in an upper hierarchy.

When the determined result is YES, in a step S157, the color of the detected finger image (a skin color of the finger, exactly) is detected, and it is determined whether or not the detected color approximates the color of the margin of the page (whether or not a parameter value defining the detected color belongs to a predetermined region including a parameter value defining the color of the margin). When a determined result is YES, the process advances to a step S165 whereas when the determined result is NO, the process advances to the step S165 via processes in steps S161 to 5163. In the step S161, the variable HandColor_set is set to “1”. In the step S163, a numerical value indicating the color detected in the step S157 is set to the variable HandColor. In the step S165, the FLG_Finger_PageTurning is set to “1”. Upon completion of the setting, the process returns to the routine in an upper hierarchy.

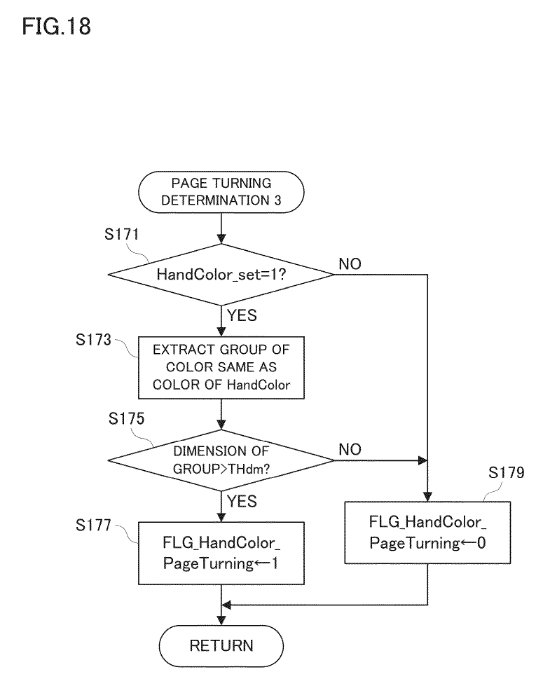

The page-turning determination process 3 in the step S117 shown in FIG. 15 is executed according to a subroutine shown in FIG. 18. In a step S171, it is determined whether or not the variable HandColor_set indicates “1”. When a determined result is NO, in a step S179, the FLG_Finger_PageTurning is set to “0”, and thereafter, the process returns to the routine in an upper hierarchy. When the determined result is YES, the process advances to a step S173, a group image having the same color as the color specified by the variable HandColor is extracted from the image data belonging to the document page region. In a step S175, it is determined whether or not a dimension of the extracted group image exceeds the threshold value THdm. When a determined result is NO, the process returns to the routine in an upper hierarchy whereas when the determined result is YES, in a step S177, FLG_Finger_PageTurning is set to “1”, and thereafter, the process returns to the routine in an upper hierarchy.

As can be seen from the above-described explanation, the imager 18 repeatedly outputs an image representing a scene captured on the imaging surface. When the document photographing mode is selected, the CPU 32 defines the document page region within the scene captured on the imaging surface (S55 to S59), and searches for one or at least two characteristic images including the page edge from the partial image data belonging to the document page region (S107, S113 and S117). Moreover, the CPU 32 detects the termination of the page turning operation based on the search result (S67), and extracts the YUV-formatted image data that is based on the raw image data outputted from the imager 18 at a timing of detection to the still-image area 26b (S71 to S75). Thereby, the imaging performance for the document page is improved.

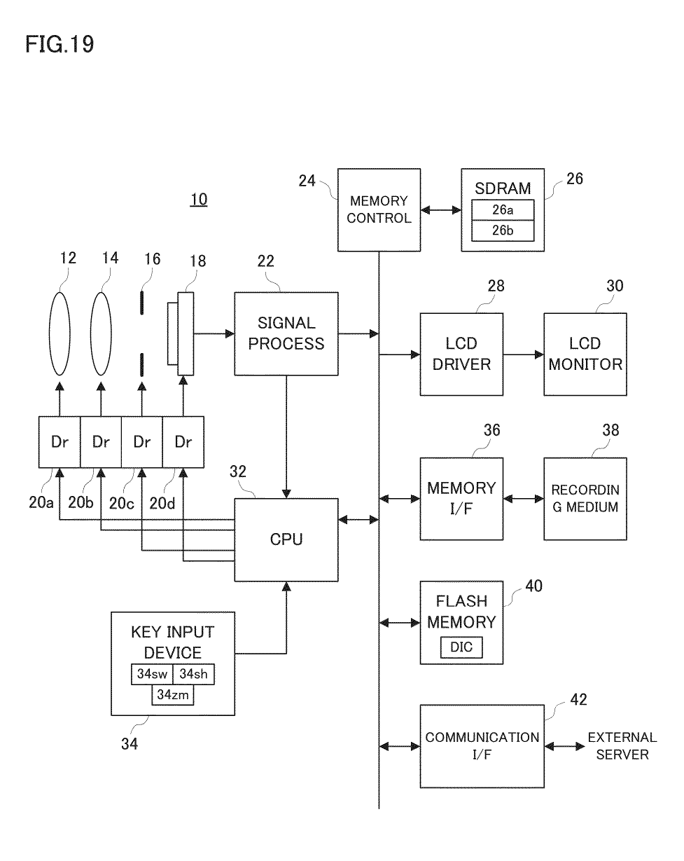

Moreover, in this embodiment, the control programs equivalent to the multi task operating system and the plurality of tasks executed thereby are previously stored in the flash memory 40. However, a communication I/F 42 may be arranged in the digital camera 10 as shown in FIG. 19 so as to initially prepare a part of the control programs in the flash memory 40 as an internal control program whereas acquire another part of the control programs from an external server as an external control program. In this case, the above-described procedures are realized in cooperation with the internal control program and the external control program.

Moreover, in this embodiment, the processes executed by the CPU 32 are divided into a plurality of tasks in a manner described above. However, these tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene captured on an imaging surface;
a definer which executes a process of defining a document page region within the scene captured on the imaging surface, corresponding to a document page photographing mode;
a searcher which searches for one or at least two characteristic images including a page edge from a partial image belonging to the document page region defined by said definer out of the image outputted from said imager;
a detector which detects a termination of a page turning operation based on a search result of said searcher; and
an extractor which extracts the image outputted from said imager corresponding to a detection of said detector.

2. An electronic camera according to claim 1, wherein said searcher includes a finger image searcher which searches for a finger image representing a finger of a person as one of the one or at least two characteristic images.

3. An electronic camera according to claim 2, wherein said searcher further includes a specific image searcher which searches for a partial image having a color equivalent to a color of the finger image detected by said finger image searcher and a dimension exceeding a reference, as one of the one or at least two characteristic images.

4. An electronic camera according to claim 3, wherein said searcher further includes a restrictor which restricts a process of said specific image searcher when the color of the finger image detected by said finger image searcher approximates a color of a margin of a document page.

5. An electronic camera according to claim 1, wherein said detector detects a transition from a state where at least one of one or at least two search results respectively corresponding to the one or at least two characteristic images indicates detection to a state where all of the one or at least two search results respectively corresponding to the one or at least two characteristic images indicates non-detection, as the termination of the page turning operation.

6. An electronic camera according to claim 1, further comprising an adjuster which adjusts a zoom magnification so as to be adapted to a size of the document page region defined by said definer, wherein said searcher executes a searching process after a process of said adjuster.

7. An electronic camera according to claim 1, further comprising a creator which creates a file containing one or at least two images extracted by said extractor.

8. An electronic camera according to claim 1, further comprising a modifier which modifies a partial image belonging to a region surrounding the document page region defined by said definer out of the image extracted by said extractor to a single-color image having the color of the margin of the document page.

9. An imaging control program recorded on a non-transitory recording medium in order to control an electronic camera provided with an imager which outputs an image representing a scene captured on an imaging surface, the program causing a processor of the electronic camera to perform the steps comprising:
a defining step of executing a process of defining a document page region within the scene captured on the imaging surface, corresponding to a document page photographing mode;
a searching step of searching for one or at least two characteristic images including a page edge from a partial image belonging to the document page region defined by said defining step out of the image outputted from said imager;
a detecting step of detects a termination of a page turning operation based on a search result of said searching step; and
an extracting step of extracting the image outputted from said imager corresponding to a detection of said detecting step.

10. An imaging control method executed by an electronic camera provided with an imager which outputs an image representing a scene captured on an imaging surface, comprising:
a defining step of executing a process of defining a document page region within the scene captured on the imaging surface, corresponding to a document page photographing mode;
a searching step of searching for one or at least two characteristic images including a page edge from a partial image belonging to the document page region defined by said defining step out of the image outputted from said imager;
a detecting step of detects a termination of a page turning operation based on a search result of said searching step; and
an extracting step of extracting the image outputted from said imager corresponding to a detection of said detecting step.
